(19) United States
(12) Patent Application Publication
(10) Pub. No.: US 2025/0225762 A1
(43) Pub. Date: Jul. 10, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventors: Yasunori BABAZAKI, Tokyo (JP); Yasuto Nagase, Tokyo (JP)

(73) Assignee: NEC Corporation, Tokyo (JP)

(21) Appl. No.: 18/987,591

(22) Filed: Dec. 19, 2024

(30) Foreign Application Priority Data
Jan. 4, 2024 (JP) 2024-040386

(51) Int. Cl. G06V 10/25

(52) U.S. Cl. CPC G06V 10/25; G06V 2201/07

(57) ABSTRACT

An information processing apparatus includes: a text group obtaining section which obtains a visually expressing text group that includes a plurality of texts which visually express a detection target, with reference to input data that specifies the detection target; a prompt generating section which generates a prompt with reference to the visually expressing text group; and a providing section which provides, to a detection model, the prompt that has been generated by the prompt generating section, the detection model being a model into which a prompt and an image are inputted and which detects, from the image, a detection target that is specified by the prompt.

This application is based upon and claims the benefit of priority from Japanese patent application No. 2024-040386, filed on Mar. 14, 2024, the disclosure of which is incorporated herein in its entirety by reference.

### TECHNICAL FIELD

The present disclosure relates to an information processing apparatus, an information processing method, and a recording medium.

### BACKGROUND ART

There is known an image recognition technique of recognizing (detecting) an object in an image (for example, Patent Literature 1). In such a technique, required to carry out accurate recognition (detection) regarding an object.

### CITATION LIST

### Patent Literature

### Patent Literature 1

Japanese Patent Application Publication Tokukaihei No. 05-174147

### SUMMARY OF INVENTION

### Technical Problem

Meanwhile, in recent years, there has been known a text-based object detecting technique of training an object detector so that an object in an image and a text prompt that expresses the object are linked with each other. In such a technique, since the accuracy of object detection depends on a prompt, it is desirable to generate a more suitable prompt. However, generating a suitable prompt has been a burden on a user.

The present disclosure has been made in view of the above problem, and an example object thereof is to provide a technique which makes it possible to generate a suitable prompt for detecting an object in an image.

### Solution to Problem

An information processing apparatus in accordance with an example aspect of the present disclosure includes at least one processor, the at least one processor executing: a text group obtaining process of obtaining a visually expressing text group that includes a plurality of texts which visually express a detection target, with reference to input data that specifies the detection target; a prompt generating process of generating a prompt with reference to the visually expressing text group; and a providing process of providing, to a detection model, the prompt that has been generated in the prompt generating process, the detection model being a model into which a prompt and an image are inputted and which detects, from the image, a detection target that is specified by the prompt.

An information processing apparatus in accordance with an example aspect of the present disclosure includes at least one processor, the at least one processor executing: an obtaining process of obtaining input data that specifies a detection target; and a providing process of providing, to a detection model, a prompt that is obtained with reference to the input data, the detection model being a model into which a prompt and an image are inputted and which detects, from the image, a detection target that is specified by the prompt, the prompt that is provided by the at least one processor in the providing process being generated in a process including: a text group obtaining process of obtaining a visually expressing text group that includes a plurality of texts which visually express the detection target; and a prompt generating process of generating a prompt with reference to the visually expressing text group.

An information processing method in accordance an example aspect of the present disclosure includes: (a) obtaining a visually expressing text group that includes a plurality of texts which visually express a detection target, with reference to input data that specifies the detection target; (b) generating a prompt with reference to the visually expressing text group; and (c) providing, to a detection model, the prompt that has been generated, the detection model being a model into which a prompt and an image are inputted and which detects, from the image, a detection target that is specified by the prompt, (a) through (c) being carried out by at least one processor.

Note that the information processing apparatus in accordance with each aspect may be realized by a computer. In this case, the present invention also encompasses, in its scope, (i) a program for causing a computer to operate as each means included in the information processing apparatus so that the information processing apparatus is realized by the computer and (ii) a computer-readable recording medium in which the program is recorded.

### Advantageous Effects of Invention

An example aspect of the present disclosure brings about an example effect that it is possible to generate a suitable prompt for detecting an object in an image.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a block diagram illustrating a configuration of an information processing system in accordance with the present disclosure.

FIG. 6 is a diagram illustrating a process carried out by the information processing system in accordance with the present disclosure.

FIG. 7 is a diagram illustrating a process carried out by the information processing system in accordance with the present disclosure.

FIG. 8 is a diagram illustrating a process carried out by the information processing system in accordance with the present disclosure.

FIG. 9 is a diagram illustrating a process carried out by the information processing system in accordance with the present disclosure.

FIG. 10 is a diagram illustrating a process carried out by the information processing system in accordance with the present disclosure.

FIG. 11 is a block diagram illustrating a configuration of an information processing system in accordance with the present disclosure.

FIG. 12 is a block diagram illustrating a configuration of a computer which functions as an information processing apparatus in accordance with the present disclosure.

### EXAMPLE EMBODIMENTS

The following will exemplify embodiments of the present invention. Note, however, that the present invention is not limited to the example embodiments described below, but may be altered in various ways by a skilled person within the scope of the claims. For example, the present invention can also encompass, in its scope, any example embodiment derived by appropriately combining technical means employed in the example embodiments described below. Further, the present invention can also encompass, in its scope, any example embodiment derived by appropriately omitting a part of a technical means employed in each of the example embodiments described below. Further, the effects mentioned in the example embodiments described below are examples of the effects expected in the example embodiments described below, and are not intended to define an extension of the present invention. That is, the present invention can also encompass, in its scope, any example embodiment that does not bring about any of the effects mentioned in the example embodiments described below.

### FIRST EXAMPLE EMBODIMENT

The following description will discuss a first example embodiment, which is an example of an embodiment of the present invention, in detail, with reference to the drawings. The present example embodiment is a basic form of the example embodiments described later. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means which are indicated in the drawings referred to for describing the present example embodiment can be employed also in the other example embodiments included in the present disclosure, within a range in which no particular technical problem occurs.

### (Configuration of Information Processing Apparatus 1)

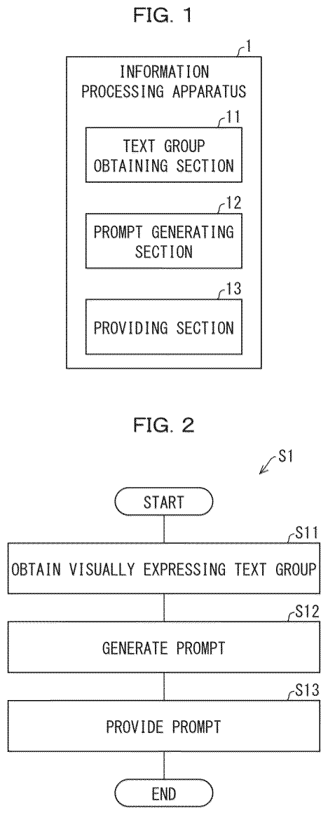

A configuration of an information processing apparatus 1 in accordance with the present example embodiment is described below with reference to FIG. 1. FIG. 1 is a block diagram illustrating the configuration of the information processing apparatus 1 in accordance with the present example embodiment. As illustrated in FIG. 1, the information processing apparatus 1 includes a text group obtaining section 11, a prompt generating section 12, and a providing section 13.

### (Text Group Obtaining Section 11)

The text group obtaining section 11 obtains a visually expressing text group that includes a plurality of texts which visually express a detection target, with reference to input data that specifies the detection target. Note, here, that the input data referred to by the text group obtaining section 11 includes, as an example, a phrase (text) for identifying the detection target (object) included in a target image. The text group obtaining section 11 may refer to the input data that has been obtained in advance and is stored in a storage section which is not illustrated, or may refer to the input data that has been obtained from a user via an input section which is not illustrated.

The “texts which visually express a detection target” which are included in the text group obtained by the text group obtaining section 11 can be, for example, texts that identify a color of the detection target, the shape of the detection target, movement of the detection target, the type of the detection target, an environment surrounding the detection target, and the like. However, these examples do not limit the present example embodiment. The phrase “visually express a detection target” does not limit the present example embodiment, and may be simply read as “express a detection target”. Similarly, the phrase “visually expressing text group” does not limit the present example embodiment, and may be expressed as “text group”, “object expressing text group”, and the like.

As an example, the text group obtaining section 11 may obtain (generate) the plurality of texts which visually express the detection target, by inputting the input data into a language model that has been trained by machine learning in advance. As another example, the text group obtaining section 11 may obtain (generate) the plurality of texts which visually express the detection target, by comparing the input data with correspondence information that has been created in advance. Note, however, that these examples do not limit the present example embodiment.

### (Prompt Generating Section 12)

The prompt generating section 12 generates a prompt with reference to the visually expressing text group that has been obtained by the text group obtaining section 11. Note, here, that a prompt generating process carried out by the prompt generating section 12 may include:
an evaluating process of evaluating appropriateness of at least any text included in the visually expressing text group; and
a selecting process of selecting, from the visually expressing text group, one or more texts to be used to generate the prompt, with reference to a result of the evaluating process.

However, these examples do not limit the present example embodiment.

### (Providing Section 13)

The providing section 13 provides, to a detection model, the prompt that has been generated by the prompt generating section 12. The detection model is a model into which a prompt and an image are inputted and which detects, from the image, a detection target that is specified by the prompt. The information processing apparatus 1 may further include a configuration that obtains a detection result which has been outputted by the detection model and that generates output information with reference to the detection result. However, this does not limit the present example embodiment.

### (Effect of Information Processing Apparatus 1)

As has been described, the information processing apparatus 1 in accordance with the present example embodiment employs a configuration such that
a visually expressing text group that includes a plurality of texts which visually express a detection target is obtained with reference to input data that specifies the detection target,
a prompt is generated with reference to the visually expressing text group, and
the prompt that has been generated is provided to a detection model into which a prompt and an image are inputted and which detects, from the image, a detection target that is specified by the prompt.

According to the above configuration, since the visually expressing text group that includes the plurality of texts which visually express the detection target is obtained and then the prompt is generated with reference to the visually expressing text group, it is possible to generate a suitable prompt that is to be provided to a detection model which detects a detection target from an image on the basis of a prompt. In other words, it is possible to generate a suitable prompt for detecting an object in an image.

### (Flow of Information Processing Method S1)

Next, a flow of an information processing method S1 in accordance with the present example embodiment is described with reference to FIG. 2. FIG. 2 is a flowchart illustrating the flow of the information processing method S1. The information processing method S1 includes, as illustrated in FIG. 2, a process (step) S11 of obtaining a visually expressing text group, a process (step) S12 of generating a prompt, and a process (step) S13 of providing the prompt.

### (Step S11)

In the step S11, the text group obtaining section 11 obtains a visually expressing text group that includes a plurality of texts which visually express a detection target, with reference to input data that specifies the detection target. A detailed process carried out by the text group obtaining section 11 has been described above, and therefore description thereof is omitted here.

### (Step S12)

In the step S12, the prompt generating section 12 generates a prompt with reference to the visually expressing text group that has been obtained by the text group obtaining section 11 in the step S11. A detailed process carried out by the prompt generating section 12 has been described above, and therefore description thereof is omitted here.

### (Step S13)

In the step S13, the providing section 13 provides, to a detection model, the prompt that has been generated by the prompt generating section 12 in the step S12. The detection model is a model into which a prompt and an image are inputted and which detects, from the image, a detection target that is specified by the prompt.

### (Effect of Information Processing Method S1)

As has been described, the information processing method S1 in accordance with the present example embodiment employs a configuration such that:
a visually expressing text group that includes a plurality of texts which visually express a detection target is obtained with reference to input data that specifies the detection target,
a prompt is generated with reference to the visually expressing text group, and
the prompt that has been generated is provided to a detection model into which a prompt and an image are inputted and which detects, from the image, a detection target that is specified by the prompt.

According to the information processing method S1 including the above processes, an effect similar to that brought about by the information processing apparatus 1 in accordance with the present example embodiment is brought about.

### (Configuration of Information Processing Apparatus 2)

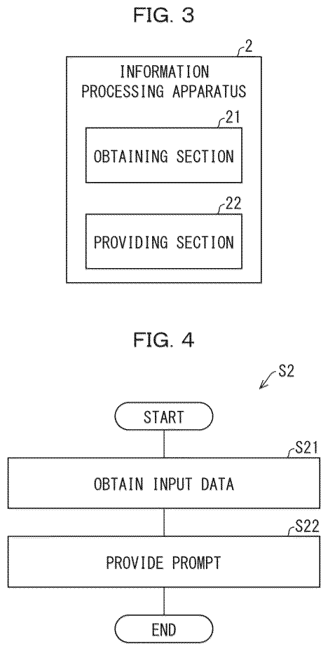

Next, a configuration of an information processing apparatus 2 in accordance with the present example embodiment is described with reference to FIG. 3. FIG. 3 is a block diagram illustrating the configuration of the information processing apparatus 2 in accordance with the present example embodiment. As illustrated in FIG. 3, the information processing apparatus 2 includes an obtaining section 21 and a providing section 22.

### (Obtaining Section 21)

The obtaining section 21 obtains input data that specifies a detection target. Note, here, that the input data includes, as an example, a phrase (text) for identifying the detection target (object) included in a target image. The obtaining section 21 may obtain the input data that is stored in a storage section which is not illustrated, or may obtain the input data that has been accepted from a user via an input section which is not illustrated.

### (Providing Section 22)

The providing section 22 provides, to a detection model, a prompt that is obtained with reference to the input data. The detection model is a model into which a prompt and an image are inputted and which detects, from the image, a detection target that is specified by the prompt. Note, here, that the prompt that is provided to the detection model by the providing section 22 is, as an example, generated by a process including:
a text group obtaining process of obtaining a visually expressing text group that includes a plurality of texts which visually express the detection target; and:
a prompt generating process of generating a prompt with reference to the visually expressing text group. Alternatively, as the prompt, a prompt that has been generated by the prompt generating section 12 included in the above-described information processing apparatus 1 may be used.

The information processing apparatus 2 may further include a configuration that obtains a detection result which has been outputted by the detection model and that generates output information with reference to the detection result. However, this does not limit the present example embodiment.

### (Effect of Information Processing Apparatus 2)

As has been described, the information processing apparatus 2 in accordance with the present example embodiment employs a configuration such that
input data that specifies a detection target is obtained,
a prompt that is obtained with reference to the input data is provided to a detection model into which a prompt and an image are inputted and which detects, from the image, a detection target that is specified by the prompt,
   the prompt that is provided to the detection model being generated by a process including:
a text group obtaining process of obtaining a visually expressing text group that includes a plurality of texts which visually express the detection target; and
a prompt generating process of generating a prompt with reference to the visually expressing text group. According to the above configuration, a suitable prompt is generated with reference to the visually expressing text group that includes the plurality of texts which visually express the detection target. Moreover, with use of the suitable prompt, it is possible to suitably detect an object by a detection model.

### (Flow of Information Processing Method S2)

Next, a flow of an information processing method S2 in accordance with the present example embodiment is described with reference to FIG. 4. FIG. 4 is a flowchart illustrating the flow of the information processing method S2. The information processing method S2 includes, as illustrated in FIG. 4, a process (step) S21 of obtaining input data and a process (step) S22 of providing a prompt.

### (Step S21)

In the step S21, the obtaining section 21 obtains input data that specifies a detection target. A detailed process carried out by the obtaining section 21 has been described above, and therefore description thereof is omitted here.

### (Step S22)

In the step S22, the providing section 22 provides, to a detection model, a prompt that is obtained with reference to the input data which has been obtained in the step S21. The detection model is a model into which a prompt and an image are inputted and which detects, from the image, a detection target that is specified by the prompt. Note, here, that the prompt that is provided to the detection model by the providing section 22 in this step is, as an example, generated by a process including:
a text group obtaining process of obtaining a visually expressing text group that includes a plurality of texts which visually express the detection target; and
a prompt generating process of generating a prompt with reference to the visually expressing text group. Alternatively, as the prompt, a prompt that has been generated in the above-described information processing method S1 may be used.

### (Effect of Information Processing Method S2)

As has been described, the information processing method S2 in accordance with the present example embodiment employs a configuration such that
input data that specifies a detection target is obtained,
a prompt that is obtained with reference to the input data is provided to a detection model into which a prompt and an image are inputted and which detects, from the image, a detection target that is specified by the prompt,
   the prompt that is provided to the detection model being generated by a process including:
a text group obtaining process of obtaining a visually expressing text group that includes a plurality of texts which visually express the detection target; and
a prompt generating process of generating a prompt with reference to the visually expressing text group. According to the information processing method S2 including the above processes, an effect similar to that brought about by the information processing apparatus 2 in accordance with the present example embodiment is brought about.

### SECOND EXAMPLE EMBODIMENT

The following description will discuss a second example embodiment, which is an example of an embodiment of the present invention, in detail, with reference to the drawings. The same reference signs are given to constituent elements having the same functions as those of the constituent elements described in the foregoing example embodiment, and descriptions of the constituent elements are omitted as appropriate. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing System 100A)

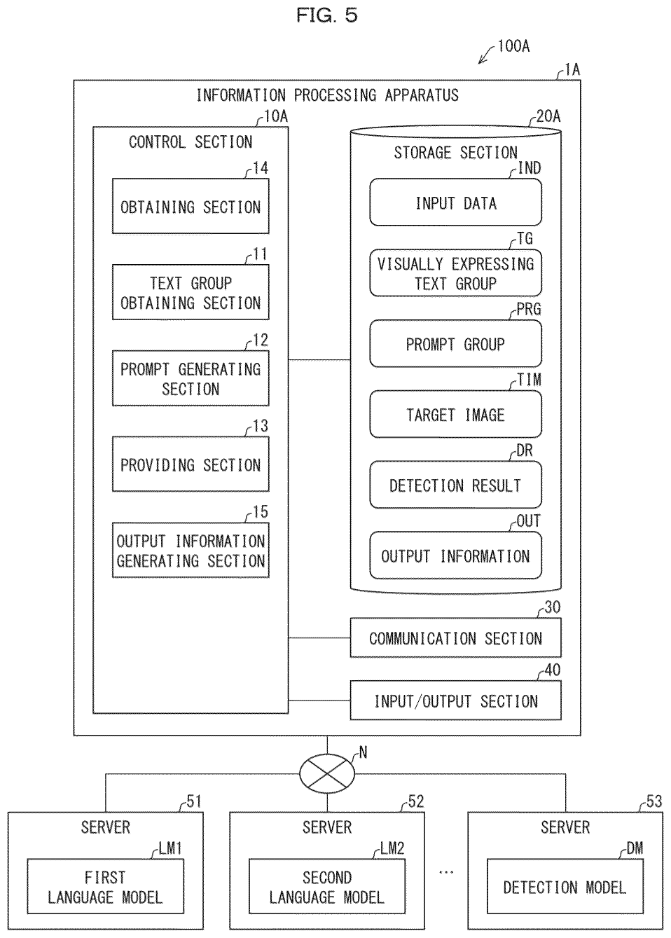

A configuration of an information processing system 100A in accordance with the present example embodiment is described with reference to FIG. 5. FIG. 5 is a block diagram illustrating the configuration of the information processing system 100A. The information processing system 100A includes, as illustrated in FIG. 5, an information processing apparatus 1A and a plurality of servers 51, 52, 53, . . . that are connected to the information processing apparatus 1A via a network N. Note, here, that, although a detailed configuration of the network N does not limit the present example embodiment, the network N can be, for example, a wireless local area network (LAN), a wired LAN, a wide area network (WAN), a public network, a mobile data communication network, or a combination of any of these networks. Note that it is not essential for the information processing system 100A to include the plurality of servers 51, 52, 53, . . . , and the information processing apparatus 1A may have the functions of these servers. Such a configuration is also encompassed in the present example embodiment.

### (Servers)

As illustrated in FIG. 5, the information processing system 100A includes the plurality of servers 51, 52, 53, . . . , as an example. In an example illustrated in FIG. 5, the server 51 includes a first language model LM1. Various pieces of data provided from the information processing device 1A are inputted into the first language model LM1, and output data outputted by the first language model LM1 is provided to the information processing apparatus 1A. Similarly, the server 52 includes a second language model LM2. Various pieces of data provided from the information processing device 1A are inputted into the second language model LM2, and output data outputted by the second language model LM2 is provided to the information processing apparatus 1A. Note, here, that the first language model LM1 and the second language model LM2 are large language models (LLM) that differ from each other, and are, as an example, large language models that have been trained with reference to differing pieces of training data.

The server 53 includes a detection model DM into which a prompt and an image are inputted and which detects, from the image, a detection target that is specified by the prompt. An image and a prompt provided from the information processing apparatus 1A are inputted into the detection model DM, and output data (detection result) outputted by the detection model is provided to the information processing apparatus 1A.

Details of the detection model DM do not limit the present example embodiment, but the detection model DM is, as an example, a model that has been trained such that an object in an image and a text prompt that expresses the object are linked with each other. More specifically, the detection model DM is a model that has been trained with reference to training data including a plurality of image-text sets each of which includes (i) an image and (ii) a text that expresses each of one or more objects included in the image.

Through a training process as described above as an example, the detection model DM is configured to be capable of detecting a detection target from a target image with reference to a prompt that includes a text expression which expresses the detection target.

### (Configuration of Information Processing Apparatus 1A)

Next, a configuration of the information processing apparatus 1A in accordance with the present example embodiment is described with reference to FIG. 5. As illustrated in FIG. 5, the information processing apparatus 1A includes a control section 10A, a storage section 20A, a communication section 30, and an input/output section 40.

### (Communication Section 30)

The communication section 30 carries out communication with an apparatus provided outside the information processing apparatus 1A. As an example, the communication section 30 carries out communication with the plurality of servers 51, 52, 53, . . . . The communication section 30 transmits, to any of the plurality of servers 51, 52, 53, . . . , data that has been supplied from the control section 10A, and supplies, to the control section 10A, data that has been received from any of the plurality of servers 51, 52, 53, . . . .

Note that the data that is transmitted to each of the servers 51 and 52 by the communication section 30 can include:
a prompt for generating a visually expressing text group (described later) (text group generation prompt); and
a prompt for evaluating the visually expressing text group (text group evaluation prompt).

The data that is received by the communication section 30 from each of the servers 51 and 52 can include:
one or more visually expressing texts that have been outputted by a corresponding one of the language models LM1 and LM2 which has referred to the text group generation prompt; and
an evaluation result that is a result of evaluating the one or more visually expressing texts and that has been outputted by a corresponding one of the language models LM1 and LM2 which has referred to the text group evaluation prompt.

The data that is transmitted to the server 53 by the communication section 30 can include:
a target image; and
a prompt for detecting a detection target from the target image (detection prompt).

The data that is received by the communication section 30 from the server 53 can include
a detection result outputted by the detection model DM which has referred to the detection prompt.

### (Input/Output Section 40)

The input/output section 40 includes at least any of input/output apparatuses such as a keyboard, a mouse, a display, a printer, and a touch panel. Alternatively, at least any of input/output apparatuses such as a keyboard, a mouse, a display, a printer, and a touch panel may be connected to the input/output section 40. In this case, the input/output section 40 accepts, from an input apparatus connected thereto, input of various pieces of information with respect to the information processing apparatus 1A. Further, the input/output section 40 outputs various pieces of information to an output apparatus connected thereto under control by the control section 10A. Examples of the input/output section 40 include interfaces such as a universal serial bus (USB).

### (Storage Section 20A)

In the storage section 20A, various pieces of data that are referred to by the control section 10A and various pieces of data that have been generated by the control section 10A are stored. As an example, in the storage section 20A,
input data IND,
a visually expressing text group TG,
a prompt group PR,
a target image TIM,
a detection result DR,
output information OUT,
   and the like are stored.

Note, here, that the input data IND include, as an example, a phrase (text) for identifying a detection target (object) included in a target image. As an example, the input data IND is inputted from a user via the input/output section 40, and stored in the storage section 20A. As another example, the input data IND is obtained from another apparatus via the communication section 30, and stored in the storage section 20A.

The visually expressing text group TG is a text group that includes one or more texts which have been obtained (generated) by a text group obtaining section 11 (described later). Details of the visually expressing text group TG will be described later.

The prompt group PRG includes prompts that have been generated by a prompt generating section 12 (described later). As an example, the prompt group PRG includes:
a prompt for generating a visually expressing text group (text group generation prompt TGP);
a prompt for evaluating the visually expressing text group (text group evaluation prompt TEP); and
a prompt for detecting a detection target from a target image (detection prompt DP).

These prompts are generated, as an example, by the prompt generating section 12. Details of the prompt group PRG will be described later.

The target image TIM is an image that is subjected to a detecting process, and is, as an example, an image that is provided to the server 53. The detection model included in the server 53 detects a detection target from the target image TIM with reference to the target image TIM and the detection prompt DP. Details of the target image TIM will be described later.

The detection result DR is a detection result that is outputted by the detection model DM into which the target image TIM and the detection prompt DP have been inputted. Details of the detection result DR will be described later.

The output information OUT is information for output that has been generated by an output information generating section 15 (described later) with reference to the detection result DR. As an example, the output information OUT is presented to a user via the input/output section 40. Details of the output information OUT will be described later.

### (Control Section 10A)

The control section 10A includes, as illustrated in FIG. 5, an obtaining section 14, the text group obtaining section 11, the prompt generating section 12, information a providing section 13, and the output generating section 15.

### (Obtaining Section 14)

The obtaining section 14 obtains the input data IND. The obtaining section 14 may obtain the input data IND that has been inputted from a user via the input/output section 40, or may obtain the input data IND that is stored in the storage section 20A. As described above, the input data IND includes, as an example, a phrase (text) for identifying a detection target (object) included in a target image. A detailed example of the input data IND will be described later. The obtaining section 14 also obtains, via the communication section 30, output data that is outputted by each of the plurality of servers 51, 52, 53, . . . included in the information processing system 100A.

### (Text Group Obtaining Section 11)

The text group obtaining section 11 obtains the visually expressing text group TG that includes a plurality of texts which visually express a detection target, with reference to the input data IND that has been obtained by the obtaining section 14. As an example, the text group obtaining section 11 obtains (generates) a plurality of texts which visually express a detection target, from a phrase (text) included in the input data IND. The plurality of texts constitute the visually expressing text group TG.

Note that, as in the first example embodiment, the “texts which visually express a detection target” can be, for example, texts that identify a color of the detection target, the shape of the detection target, movement of the detection target, the type of the detection target, an environment surrounding the detection target, and the like. However, these examples do not limit the present example embodiment. The phrase “visually express a detection target” does not limit the present example embodiment, and may be simply read as “express a detection target”. Similarly, the phrase “visually expressing text group” does not limit the present example embodiment, and may be expressed as “text group”, “object expressing text group”, and the like.

Alternatively, as an example, the text group obtaining section 11 may provide, to the language model LM1 or LM2 included in the server 51 or 52, the text group generation prompt TGP that is obtained with reference to the input data IND, and use, as the visually expressing text group TG, a text group that is outputted by the language model LM1 or LM2.

As an example, in a case where a “rolling compaction machine” is designated as a detection target in the input data IND, the text group obtaining section 11 may provide, to at least any of the language models LM1 and LM2, the text group generation prompt TGP such as

“Please enumerate a plurality of visual features for detecting a rolling compaction machine on an image”. Alternatively, the text group obtaining section 11 may obtain, as an answer to the text group generation prompt TGP, an answer such as

“In order to detect a rolling compaction machine, there are the following visual features:
a conical shape, a handle, on the ground, there is shadow”
   from at least any of the language models LM1 and LM2, and include, in the visually expressing text group TG, each text included in the answer.

Note that a process carried out by the text group obtaining section 11 is not limited to the above example. As another example, without use of the language models LM1 and LM2, the text group obtaining section 11 may generate the visually expressing text group TG that includes a plurality of texts which visually express a detection target, by comparing the input data IND with correspondence information that has been generated in advance. A more detailed process carried out by the text group obtaining section 11 will be described later.

### (Prompt Generating Section 12)

The prompt generating section 12 generates a prompt with reference to the visually expressing text group TG that has been generated by the text group obtaining section 11. As an example, the prompt generating section 12 generates the detection prompt DP for detecting a detection target from the target image TIM with reference to the visually expressing text group TG. Note, here, that a prompt generating process carried out by the prompt generating section 12 may include:
an evaluating process of evaluating appropriateness of at least any text included in the visually expressing text group TG; and
a selecting process of selecting, from the visually expressing text group TG, one or more texts to be used to generate the detection prompt DP, with reference to a result of the evaluating process.

For example, the text group obtaining section 11 may generate the text group evaluation prompt TEP such as “Please enumerate only visual features which are useful for detecting a rolling compaction machine, among the following visual features:
a conical shape, a handle, on the ground, there is shadow”
   and provide the text group evaluation prompt TEP to at least any of the language models LM1 and LM2. In a case where the text group obtaining section 11 obtains, from at least any of the language models LM1 and LM2, an answer
   “a conical shape, a handle, on the ground”
   as an answer to the text group evaluation prompt TEP, the text group obtaining section 11 may select only a text(s) included in the answer, as a text(s) to be used to generate the detection prompt DP.

In the prompt generating process carried out by the prompt generating section 12, the prompt generating section 12 may execute
a searching process of searching for a text other than the one or more texts that have been selected in the selecting process, as an additional text to be used to generate the detection prompt DP.

As an example, the text group obtaining section 11 may generate a search prompt such as “Visual features for detecting a rolling compaction machine are as below. Are there any other conceivable visual features?
a conical shape, with a handle, on the ground” and provide the search prompt to at least any of the language models LM1 and LM2. In a case where the text group obtaining section 11 obtains, from at least any of the language models LM1 and LM2, an answer such as “with wheels”,
   as an answer to the e search prompt, the text group obtaining section 11 may include, in the visually expressing text group TG, “with wheels” that is a text included in the answer.

Note that, in a case where the prompt generating section 12 generates the prompt for generating the visually expressing text group TG (text group generation prompt TGP) with reference to the input data IND, the text group generation prompt TGP can include:
a phrase (text) included in the input data; and:
an instruction sentence that instructs to output one or more expressions which visually describe the phrase. The text group generation prompt TGP that has been generated is used by the text group obtaining section 11.

In a case where the prompt generating section 12 generates the prompt for evaluating the visually expressing text group TG (text group evaluation prompt TEP), the text group evaluation prompt TEP can include:
one or more texts included in the visually expressing text group TG; and:
an instruction sentence that instructs to evaluate appropriateness of each of the one or more texts.

As an example, the text group evaluation prompt TEP that has been generated is used in the above evaluating process carried out by the prompt generating section 12. More described prompts that are generated by the prompt generating section 12 will be described later with reference to different drawings.

### (Providing Section 13)

The providing section 13 provides, to the detection model DM, the prompt (detection prompt DP) that has been generated by the prompt generating section 12. The detection model DM is a model into which a prompt and the target image TIM are inputted and which detects, from the target image TIM, a detection target that is specified by the prompt. As an example, the providing section 13 provides, to the server 53, the target image TIM and the detection prompt DP that has been generated by the prompt generating section 12, via the communication section 30. Then, in the server 53, the target image TIM and the detection prompt DP are inputted into the detection model DM.

### (Output Information Generating Section 15)

The output information generating section 15 generates the output information OUT from the detection result DR that has been outputted by the detection model DM into which the detection prompt DP and the target image TIM have been inputted. As an example, the generated output information OUT is visually presented (displayed) to a user via the input/output section 40. A detailed example of the output information OUT generated by the output information generating section 15 will be described later.

### (Detailed Configuration Example of Information Processing System 100A)

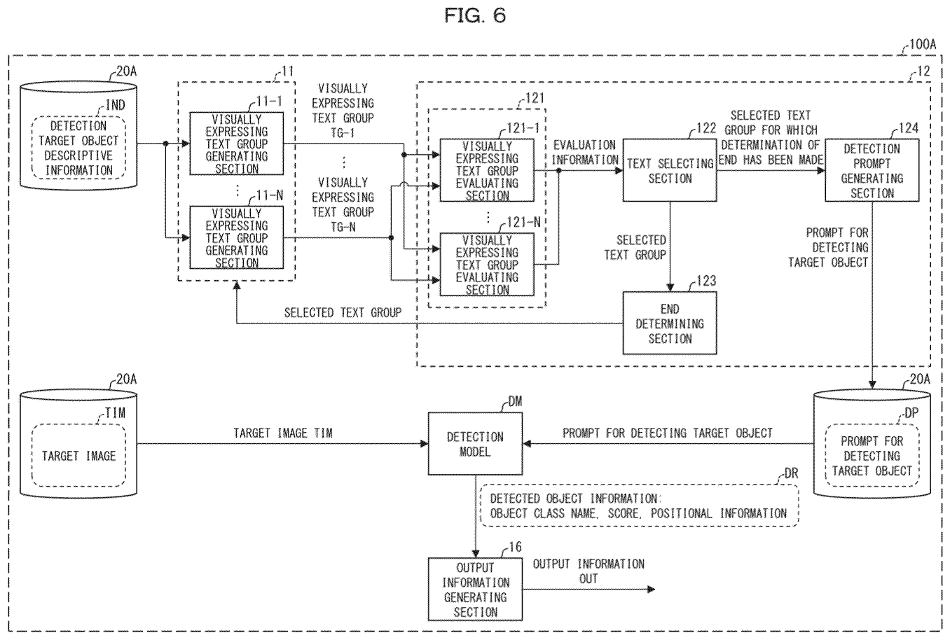

A detailed configuration example of the information processing system 100A is described below with reference to different drawings. FIG. 6 is a diagram illustrating a detailed configuration example of the information processing system 100A in accordance with the present example embodiment. Each configuration will be described below in order of processes. Note that each arrow in FIG. 6 only shows an example of a direction in which data moves. The data may move in the opposite direction or may alternatively move between constitutional elements other than constitutional elements connected by the each arrow.

First, as illustrated in FIG. 6, detection target object descriptive information is inputted into the text group obtaining section 11 as the input data IND. Note, here, that the detection target object descriptive information is information that describes an object to be detected, and includes, as an example, the name or the type of the object.

### (Text Group Obtaining Section 11)

As illustrated in FIG. 6, the text group obtaining section 11 into which the detection target object descriptive information is inputted includes, in this example, a plurality of visually expressing text group generating sections 11-1 to 11-N (N visually expressing text group generating sections in the example in FIG. 6). The detection target object descriptive information described above is inputted into each of these plurality of visually expressing text group generating sections. Note that, in the following description, each visually expressing text group generating section may be referred to as a visually expressing text group generating section 11-i, 11-j, or the like, with use of an index i, j, or the like.

As an example, each visually expressing text group generating section provides, to the language model included in each of the plurality of servers, the text group generation prompt TGP that is obtained with reference to the detection target object descriptive information, and uses, as the visually expressing text group TG, a text group that is outputted by the language model.

For example, the visually expressing text group generating section 11-1 provides, to the language model LM1 included in the server 51, the text group generation prompt TGP that is obtained with reference to the detection target object descriptive information, and uses, as a visually expressing text group TG-1, a text group that is outputted by the language model LM1.

Similarly, the visually expressing text group generating section 11-2 provides, to the language model LM2 included in the server 52, the text group generation prompt TGP, and uses, as a visually expressing text group TG-2, a text group that is outputted by the language model LM2.

Similarly, another visually expressing text group generating section 11-j (3≤j≤N) provides the text group generation prompt TGP to a corresponding language model, and uses, as a visually expressing text group TG-j (3≤j≤N), a text group that is outputted by the corresponding language model. The visually expressing text groups TG-1 to TG-N that have been generated by the visually expressing text group generating sections 11-1 to 11-N constitute the visually expressing text group TG described above.

Thus, a text group obtaining process carried out by the text group obtaining section 11 includes
a process of generating a plurality of visually expressing text groups TG-1 to TG-N with use of a plurality of generation models (language models LM1, LM2, . . . ) that differ from each other.

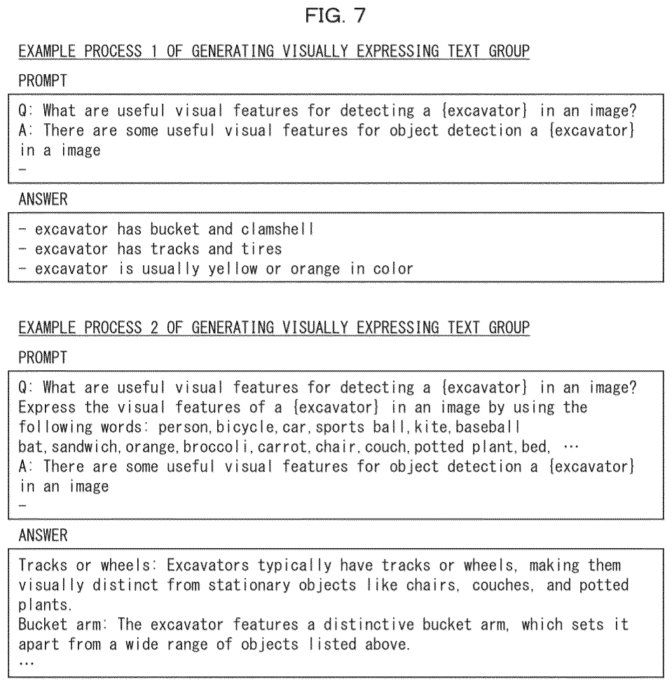

FIG. 7 illustrates example processes 1 and 2 carried out by a visually expressing text group generating section. More specifically, FIG. 7 illustrates (i) an example of a prompt (text group generation prompt TGP) that is provided to a language model by a visually expressing text group generating section 11-1 (1≤i≤N) in this example so that a visually expressing text group TG-i is generated and (ii) an example of an answer that is outputted by the language model which has referred to the prompt, in a case where “excavator” is included in the input data IND as a phrase indicating a detection target.

As illustrated in the example process 1 in an upper part of FIG. 7, the text group generation prompt TGP includes:
the phrase (“excavator” in the upper part of FIG. 7) included in the input data; and
an instruction sentence (inquiry sentence) that instructs to output one or more expressions which visually describe the above phrase (“What are useful visual features for detecting a {excavator} in an image?” in the upper part of FIG. 7).

Then, the visually expressing text group generating section 11-i in this example extracts “bucket”, “clamshell”, “tracks”, “tires”, “yellow”, and “orange” as visually expressing texts from the answer
“excavator has bucket and clamshell
excavator has tracks and tires
excavator is usually yellow or orange in color”
   that has been outputted by the language model, and generates the visually expressing text group TG-i that includes these texts.

The visually expressing text group generating section 11-i may generate the text group generation prompt TGP with use of an object name that has been explicitly learned by the detection model DM. Specifically, as illustrated in the example process 2 in a lower part of FIG. 7, the visually expressing text group generating section 11-i may generate, as the text group generation prompt TGP, a prompt that includes “person, bicycle, car, sports ball, kite, baseball bat, sandwich, orange, broccoli, carrot, chair, couch, potted plant, bed, . . . ” which are object names that have been explicitly learned by the detection model DM.

Then, the visually expressing text group generating section 11-i in this example extracts “tracks”, “wheels”, and “bucket arm” as visually expressing texts from an answer

“Tracks or wheels: Excavators typically have tracks or wheels, making them visually distinct from stationary objects like chairs, couches, and potted plants.

Bucket arm: The excavator features a distinctive bucket arm, which sets it apart from a wide range of objects listed above.

. . . .”
that has been outputted by the language model, and then generates the visually expressing text group TG-i that includes these texts.

Subsequently, as illustrated in FIG. 6, the visually expressing text groups TG-1 to TG-N are inputted into the prompt generating section 12. As illustrated in FIG. 6, the prompt generating section 12 in this example includes a text group evaluating section 121, a text selecting section 122, an end determining section 123, and a detection prompt generating section 124.

### (Text Group Evaluating Section 121)

The text group evaluating section 121 executes the evaluating process of evaluating appropriateness of at least any text included in the visually expressing text group TG. By the text group evaluating section 121 carrying out the evaluating process, it is possible to exclude, from the visually expressing text group TG, a noise expression (noise text) that is not suitable for object detection.

As illustrated in FIG. 6, the text group evaluating section 121 in this example includes a plurality of visually expressing text group evaluating sections 121-1 to 121-N (N visually expressing text group evaluating sections in the example in FIG. 6). The plurality of visually expressing text groups TG-1 to TG-N that constitute the visually expressing text group TG are inputted into each of the plurality of visually expressing text group evaluating sections 121-1 to 121-N.

Each of the visually expressing text group evaluating sections 121-1 to 121-N executes the evaluating process, as an example, by (i) providing the text group evaluation prompt TEP described above to the language model included in each of the plurality of servers and (ii) obtaining an evaluation result that is outputted by the language model.

For example, the visually expressing text group evaluating section 121-1 provides the text group evaluation prompt TEP to the language model LM1 included in the server 51, and obtains an evaluation result that is outputted by the language model LM1.

Similarly, the visually expressing text group evaluating section 121-2 provides the text group evaluation prompt TEP to the language model LM2 included in the server 52, and obtains an evaluation result that is outputted by the language model LM2.

Similarly, another visually expressing text group evaluating section 121-j (3≤j≤N) provides the text group evaluation prompt TEP to a corresponding language model, and obtains an evaluation result that is outputted by the corresponding language model.

Note, here, that, as an example, the text group evaluation prompt TEP includes:
one or more texts included in at least any of the plurality of visually expressing text groups TG-1 to TG-N; and:
an instruction sentence that instructs to evaluate appropriateness of each of the one or more texts.

The evaluating process executed by the text group evaluating section 121 thus includes a process of evaluating the plurality of visually expressing text groups TG-1 to TG-N with use of a plurality of evaluation models (language models LM1, LM2, . . . ) that differ from each other. Then, an evaluation result obtained by each of the visually expressing text group evaluating sections 121-1 to 121-N is provided to the text selecting section 122 which will be described later.

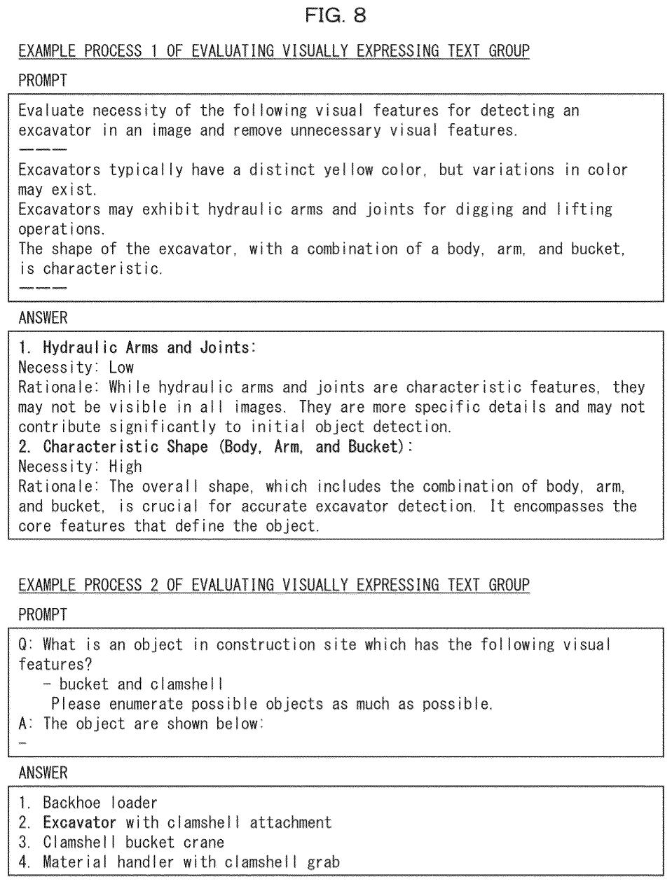

FIG. 8 illustrates example processes 1 and 2 carried out by a visually expressing text group evaluating section. More specifically, FIG. 8 illustrates (i) an example of a prompt (text group evaluation prompt TEP) that is provided to a language model by a visually expressing text group evaluating section 121-i (1≤i≤N) in this example so that an evaluation result is generated and (ii) an example of an answer that is outputted by the language model which has referred to the prompt, in a case where “excavator” is included in the input data IND as a phrase indicating a detection target.

As illustrated in the example process 1 in an upper part of FIG. 8, the text group evaluation prompt TEP includes:
the phrase (“excavator” in the upper part of FIG. 8) that indicates the detection target included in the input data;
one or more texts (“yellow”, “arm”, “bucket” in the upper part of FIG. 8) included in the visually expressing text group TG; and
an instruction sentence that instructs to evaluate appropriateness of each of the one or more texts (“Evaluate necessity of the following visual features for detecting an excavator in an image and remove unnecessary visual features.” in the upper part of FIG. 8).

Then, the visually expressing text group evaluating section 121-i in this example negatively evaluates “Hydraulic Arms and Joints” that is a visually expressing text, and positively evaluates “Body, Arm, and Bucket” that is a visually expressing text, with reference to an answer
“1. Hydraulic Arms and Joints:
Necessity: Low
Rationale: While hydraulic arms and joints are characteristic features, they may not be visible in all images. They are more specific details and may not contribute significantly to initial object detection.
2. Characteristic Shape (Body, Arm, and Bucket):
Necessity: High
Rationale: The overall shape, which includes the combination of body, arm, and bucket, is crucial for accurate excavator detection. It encompasses the core features that define the object.”
that has been outputted by the language model.

The visually expressing text group evaluating section 121-i may generate, as the text group evaluation prompt TEP, a prompt that asks what are associated with texts included in the visually expressing text group TG. As an example, as illustrated in the example process 2 in a lower part of FIG. 8, the visually expressing text group evaluating section 121-i may generate, as the text group evaluation prompt TEP, a prompt that includes
a question sentence
“Q: What is an object in construction site which has the following visual features?
   bucket and clamshell

Please enumerate possible objects as much as possible.” that asks what are associated with texts (“bucket”, “clamshell”) included in the visually expressing text group TG.

Then, the visually expressing text group evaluating section 121-i in this example may evaluate the texts (“bucket”, “clamshell”) with reference to an answer
“1. Backhoe loader
2. Excavator with clamshell attachment
3. Clamshell bucket crane
4. Material handler with clamshell grab”
   that has been outputted by the language model. In this example, the answer that has been outputted by the language model includes the detection target “excavator” that is indicated in the input data IND. Therefore, the visually expressing text group evaluating section 121-i positively evaluates the texts (“bucket”, “clamshell”) included in the visually expressing text group TG.

Note that each of the visually expressing text group evaluating sections 121-1 to 121-N may
evaluate any one visually expressing text group that corresponds to the each of the visually expressing text group evaluating sections 121-1 to 121-N, among the plurality of visually expressing text groups TG-1 to TG-N (example evaluating process 1),
evaluate one or more visually expressing text groups other than the visually expressing text group that corresponds to the each of the visually expressing text group evaluating sections 121-1 to 121-N, among the plurality of visually expressing text groups TG-1 to TG-N (example evaluating process 2), or
evaluate all of the plurality of visually expressing text groups TG-1 to TG-N(example evaluating process 3).

For example, in a case where the visually expressing text group evaluating sections 121-1, 121-2, and 121-3 evaluate the visually expressing text groups TG-1, TG-2, and TG-3,
the visually expressing text group evaluating section 121-1 may evaluate the visually expressing text group TG-1,
the visually expressing text group evaluating section 121-2 may evaluate the visually expressing text group TG-2, and
the visually expressing text group evaluating section 121-3 may evaluate the visually expressing text group TG-3 (corresponding to the example evaluating process 1). Alternatively,
the visually expressing text group evaluating section 121-1 may evaluate the visually expressing text groups TG-2 and TG-3,
the visually expressing text group evaluating section 121-2 may evaluate the visually expressing text groups TG-3 and TG-1, and
the visually expressing text group evaluating section 121-3 may evaluate the visually expressing text groups TG-1 and TG-2 (corresponding to the example evaluating process 2).

Alternatively,
the visually expressing text group evaluating section 121-1 may evaluate the visually expressing text groups TG-1 to TG-3,
the visually expressing text group evaluating section 121-2 may also evaluate the visually expressing text groups TG-1 to TG-3, and
the visually expressing text group evaluating section 121-3 may also evaluate the visually expressing text groups TG-1 to TG-3 (corresponding to the example evaluating process 3).

In a case where each of the visually expressing text group evaluating sections 121-1, 121-2, and 121-3 carries out the evaluating process with use of the language models that differ from each other, each of the example evaluating processes 2 and 3 includes a process of evaluating a visually expressing text group that has been generated by a certain language model, with use of another language model (also referred to as a mutually evaluating process).

In other words, the text group obtaining process carried out by the text group obtaining section 11 includes:
a process of generating a first text group with use of a first generation model; and
a process of generating a second text group with use of a second generation model, and
the evaluating process carried out by the text group evaluating section 121 includes:
a process of evaluating the second text group with use of a first evaluation model that includes the first generation model; and
a process of evaluating the first text group with use of a second evaluation model that includes the second generation model.

The above configuration makes it possible to obtain more various target object expressions (visual expressions), and makes it possible for the text selecting section 122 (described later) to remove an inappropriate expression that results from a bias in expressions outputted by individual language models.

### (Text Selecting Section 122)

The text selecting section 122 executes a selecting process of selecting, from the visually expressing text group TG, one or more texts to be used to generate the detection prompt DP, with reference to a result of the evaluating process carried out by the text group evaluating section 121.

As an example, in a case where, in the text group evaluating section 121, each of the N visually expressing text group evaluating sections 121-1 to 121-N carries out the evaluating process with use of the language models that differ from each other, the text selecting section 122 may
select, among the plurality of visually expressing text groups TG-1 to TG-N, a visually expressing text group(s) that has/have been positively evaluated by M (0<M<N) or more visually expressing text group evaluating sections (in other words, a visually expressing text group(s) for which an evaluation value exceeds a given criterion), as texts to be used to generate the detection prompt DP.

In other words, the text selecting section 122 may:
select, among a plurality of texts included in the plurality of visually expressing text groups TG-1 to TG-N, one or more texts that have been positively evaluated by M (0<M<N) or more visually expressing text group evaluating sections (in other words, one or more texts for which an evaluation value exceeds a given criterion), as a text(s) to be used to generate the detection prompt DP.

Alternatively, a degree of reliability may be given to each of the language models that differ from each other, and the text selecting section 122 may execute a selecting process as follows in consideration of the degree of reliability. Note, here, that, as an example, the text selecting section 122 may set the degree of reliability with reference to information such as the domain (category, field) of data that has been used by each of the language models in training. Alternatively, the selecting section 122 may set the degree of reliability with further reference to information such as the domain (category, field) of data that has been used by the detection model DM in training. For example, the selecting section 122 may carry out a process of, for example, setting the degree of reliability of the language model that has used, in training, data whose domain overlaps with the domain of data used by the detection model DM in training such that the degree of reliability of the language model is higher than the degree of reliability of the other language models.

(Example Selecting Process 1 in which Degree of Reliability is Taken into Consideration)

As an example of the selecting process in which the degree of reliability is taken into consideration, the text selecting section 122 may
select, among the plurality of texts included in the plurality of visually expressing text groups TG-1 to TG-N, a plurality of texts that have been positively evaluated by M (0<M<N) or more visually expressing text group evaluating sections, and
select, among the plurality of texts selected, a text with regard to which the sum of the degrees of reliability of the language models having been used by the visually expressing text group evaluating sections that have positively evaluated the text is equal to or higher than a given threshold, as a text to be used to generate the detection prompt DP.

For example, in a configuration in which the visually expressing text group evaluating sections 121-1, 121-2, and 121-3 use the language models LM1, LM2, and LM3 that differ from each other, respectively, exemplified is the following case:
the visually expressing text group evaluating sections 121-1 and 121-2 have positively evaluated a certain text TX1 (in other words, the language models LM1 and LM2 have carried out a positive evaluation),
the visually expressing text group evaluating sections 121-2 and 121-3 have positively evaluated another text TX2 (in other words, the language models LM2 and LM3 have carried out a positive evaluation), and
the degrees of reliability of the visually expressing text group evaluating sections 121-1, 121-2, and 121-3 (in other words, the degrees of reliability of the language models LM1, LM2, and LM3) are 0.6, 0.3, and 0.1, respectively, and the given threshold is 0.8.

In this case,
with regard to the text TX1, the sum of the degrees of reliability of the language models (LM1 and LM2) having been used by the visually expressing text group evaluating sections that have positively evaluated the text is
   0.6+0.3=0.9, and
the sum of the degrees of reliability is equal to or higher than the given threshold. Therefore, the text TX1 is selected as a text to be used to generate the detection prompt DP.

In the other hand,
with regard to the text TX2, the sum of the degrees of reliability of the language models (LM2 and LM3) having been used by the visually expressing text group evaluating sections that have positively evaluated the text is
   0.3+0.1=0.4, and
the sum of the degrees of reliability is lower than the given threshold. Therefore, the text TX2 is not selected as a text to be used to generate the detection prompt DP.
   (Example Selecting Process 2 in which Degree of Reliability is Taken into Consideration)

As another example of the selecting process which is carried out by the text selecting section 122 and in which the degree of reliability is taken into consideration, the text selecting section 122 may:
with regard to each of the plurality of texts included in the plurality of visually expressing text groups TG-1 to TG-N, calculate a linear sum which is the linear sum of evaluation values obtained by the respective plurality of visually expressing text group evaluating sections 121-1 to 121-N and in which the degrees of reliability of the language models used by the visually expressing text group evaluating sections are used as weighting factors, and
select a text with regard to which the linear sum is equal to or higher than a given threshold, as a text to be used to generate the detection prompt DP.

For example, exemplified is the following case: in a case where (i) the visually expressing text group evaluating sections 121-1, 121-2, and 121-3 use the language models LM1, LM2, and LM3 that differ from each other, respectively, and (ii) the degrees of reliability and a given threshold are given as described above,
as evaluation values for the text TX1,
   an evaluation value by the visually expressing text group evaluating section 121-1: 0.9,
   an evaluation value by the visually expressing text group evaluating section 121-2: 0.9, and
   an evaluation value by the visually expressing text group evaluating section 121-3: 0.3 are calculated, and
as evaluation values for the text TX2,
   an evaluation value by the visually expressing text group evaluating section 121-1: 0.1,
   an evaluation value the visually expressing text group evaluating section 121-2: 0.9, and
   an evaluation value by the visually expressing text group evaluating section 121-3: 0.9 are calculated. In this case,
a linear sum which is the linear sum of the evaluation values obtained by the respective visually expressing text group evaluating sections 121-1, 121-2, and 121-3 with regard to the text TX1 and in which the degrees of reliability of the language models that have been used by the respective visually expressing text group evaluating sections are used as weighting factors is
0.6×0.9+0.3×0.9+0.1×0.3=0.84, and
   the linear sum is equal to or higher than the given threshold. Therefore, the text TX1 is selected as a text to be used to generate the detection prompt DP.

On the other hand,
a linear sum which is the linear sum of the evaluation values obtained by the respective visually expressing text group evaluating sections 121-1, 121-2, and 121-3 with regard to the text TX2 and in which the degrees of reliability of the language models that have been used by respective visually expressing text group evaluating sections are used as weighting factors is
0.6×0.1+0.3×0.9+0.1×0.9=0.42, and
   the linear sum is lower than the given threshold. Therefore, the text TX2 is not selected as a text to be used to generate the detection prompt DP.

### (End Determining Section 123)

The end determining section 123
executes a searching process of searching for a text other than the one or more texts that have been selected in the selecting process by the text selecting section 122, as an additional text to be used to generate the detection prompt DP, and
gives a detection prompt generation instruction to the detection prompt generating section 124 (described later), in a case where the additional text is not found in the searching process.

As an example, the end determining section 123 instructs the visually expressing text group generating section 11-i to generate a text which visually expresses a detection target and which is other than the one or more texts that have been selected in the selecting process by the text selecting section 122. Then, as an example, the visually expressing text group generating section 11-i asks the language model whether there is such a text. In a case where such a text is found by the visually expressing text group generating section 11-i, the end determining section 123 adds the text to the visually expressing text group TG.

In a case where the above process is repeated and no additional text is ultimately found, the end determining section 123 gives the detection prompt generation instruction to the detection prompt generating section 124 (described later). By the end determining section 123 carrying out the above process, it is possible to improve the comprehensiveness of text expressions included in the visually expressing text group TG, and thus it is possible to extend clues as to object detection.

### (Detection Prompt Generating Section 124)

The detection prompt generating section 124 generates the detection prompt DP with reference to the visually expressing text group TG that has been generated by the visually expressing text group generating section 11-i and that has been positively evaluated by the visually expressing text group evaluating section 121. The detection prompt DP generated is provided to the detection model DM included in the server 53, together with the target image TIM.

The detection model DM into which the detection prompt DP and the target image TIM have been inputted detects, from the target image TIM, a detection target that is specified by the detection prompt DP, and provides the detection result DR to the information processing apparatus 1A. As an example, the detection result DR is obtained by the obtaining section 14 via the communication section 30, and stored in the storage section 20A. Note, here, that a detailed example of information included in the detection result DR does not limit the present example embodiment, but, as an example, the detection result DR can include, as illustrated in FIG. 6,
an object class name, a score, and positional information, as detected object information.

The detection result DR is, as an example, referred to and used by the output information generating section 15 so as to generate the output information OUT.

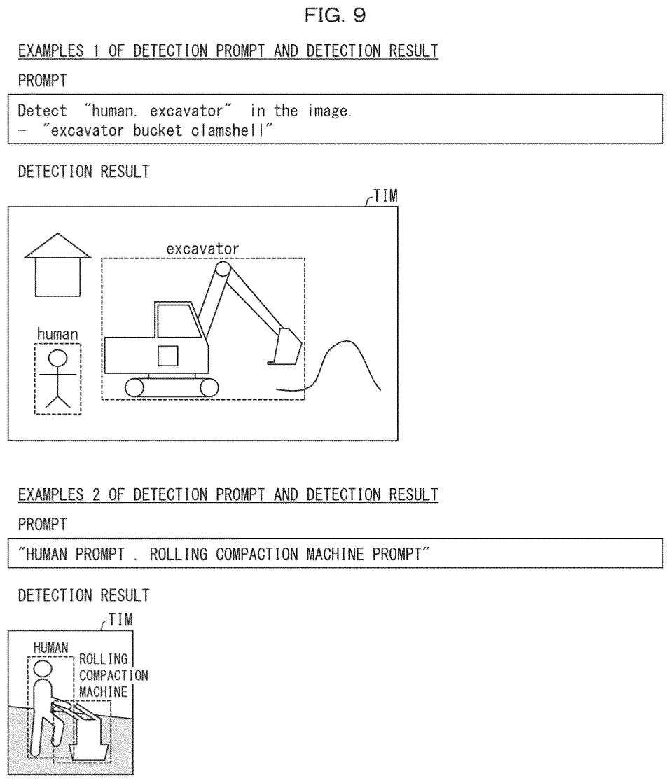

FIG. 9 illustrates (i) an example of the detection prompt DP that is generated by the detection prompt generating section 124 and (ii) an example of a detection result outputted by the detection model DM which has referred to the detection prompt DP. In an example 1 in an upper part of FIG. 9,
“Detect “human·excavator” in the image.
“excavator bucket clamshell””
   is shown as an example of the detection prompt DP, and a detection result outputted by the detection model DM which has referred to the detection prompt DP is shown. Note, here, that this detection prompt DP includes
phrases (“human” and “excavator”) that indicate detection targets included in the input data, and:
texts (“bucket” and “clamshell”) included in the visually expressing text group TG relating to the detection target “excavator”.

Note also that, in this example, as a detection result, object class names “excavator” and “human” and bounding boxes that surround these objects are shown.

In an example 2 in a lower part of FIG. 9, “human prompt·rolling compaction machine prompt” is shown as an example of the detection prompt DP, and a detection result outputted by the detection model DM which has referred to the detection prompt DP is shown. Note, here, that the “human prompt” in the detection prompt DP is a prompt for identifying a human who is a detection target. The “rolling compaction machine prompt” is a prompt for identifying a rolling compaction machine which is a detection target. At least any one of the “human prompt” and the “rolling compaction machine prompt” is accompanied by a text which visually expresses a corresponding one of the detection targets (text included in the visually expressing text group TG relating to a corresponding one of these detection targets).

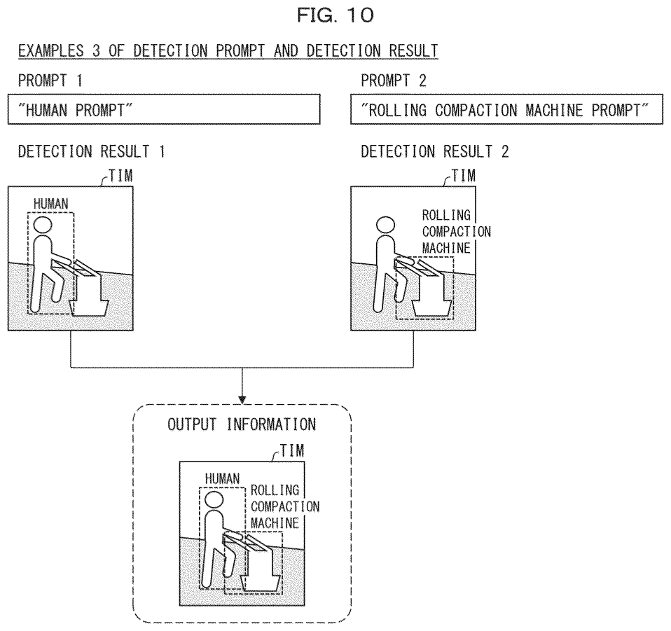

Note that the detection prompt generating section 124 may individually generate detection prompts DP for the respective plurality of detection targets included in the target image TIM. In an example 3 in FIG. 10, an example is shown in which the detection prompt generating section 124
individually generates “human prompt” and “rolling compaction machine prompt”, and
provides each prompt and the target image TIM to the detection model DM so that a detection result relating to a human (detection result 1 in FIG. 10) and a detection result relating to a rolling compaction machine (detection result 2 in FIG. 10) are individually obtained.

Then, in this example, by integrating the detection results 1 and 2, the output information generating section 15 generates the output information OUT that includes the detection results relating to the human and the rolling compaction machine.

The detection prompt DP that has been generated by the detection prompt generating section 124 and the visually expressing text group TG that has been referred to so as to generate the detection prompt DP are stored in the storage section 20A.

### (Effects of Information Processing Apparatus 1A)

As has been described, the information processing apparatus 1A in accordance with the present example embodiment employs a configuration such that
a visually expressing text group TG that includes a plurality of texts which visually express a detection target is generated with reference to input data IND that specifies the detection target,
a prompt (detection prompt DP) is generated with reference to the visually expressing text group TG, and
the prompt (detection prompt DP) that has been generated is provided to a detection model DM, the detection model DM being a model into which a prompt and an image are inputted and which detects, from the image, a detection target that is specified by the prompt. According to the above configuration, since the visually expressing text group that includes the plurality of texts which visually express the detection target is generated and then the prompt is generated with reference to the visually expressing text group, it is possible to generate a suitable prompt that is to be provided to a detection model which detects a detection target from an image on the basis of a prompt. In other words, it is possible to generate a suitable prompt for detecting an object in an image.

Moreover, since the visually expressing text group TG is automatically generated from the detection target (object class name) included in the input data IND, a user does not need to spend time and effort. Moreover, since the prompt (detection prompt DP) is generated with reference to the visually expressing text group TG and provided to the detection model DM, it is possible to highly accurately detect also an object which is not easily detected by the detection model DM (a rare object in the domain of training data for the detection model DM).

Furthermore, as described above, in the text group obtaining section 11 and the text group evaluating section 121, the visually expressing text group TG is generated and evaluated with use of language models. Thus, it is possible to automatically generate a prompt that realizes highly accurate object detection.

Furthermore, as described above, the text group obtaining section 11 and the text group evaluating section 121 are configured such that a visually expressing text group that has been generated by a certain language model is evaluated with use of another language model (also referred to as a mutually evaluating process). This makes it possible to obtain more various target object expressions, and makes it possible to generate a prompt from which a noise expression (expression inappropriate for object detection) that results from a bias in expressions outputted by language models is removed.

### (Additional Remark 1 Regarding Prompt)

A rule for generating the detection prompt that is generated by the detection prompt generating section 124 does not limit the present example embodiment, but rules as below may be used, as partly described above.

(Rule of Detection Prompt DP Inputted into Detection Model DM)

Enumerate object prompts: “P0·P1·Pi . . . PN”
wherein Pi is a prompt for an object i (0<i<N, N: the number of object types), and
“·” is a delimiter defined by the detection model DM.

### (Rules for Generating Prompt for Each Object)

Rule 1: Enumerate only visual expressions
“Vi0 Vi1 . . . ” Vij: the jth visually expressing text of the object i
   (0<j<Mi, Mi: the number of visually expressing texts of the object i)
Rule 2: Enumerate object names+visual expressions
“Ni Vi0 Vi1 . . . ”
wherein Ni is the class name of the object i.

Note, however, that the position where Ni is inserted may be a position between any visually expressing texts.

### (Additional Remark 2 Regarding Prompt)

The prompt generating section 12 may (i) present, to a user via the input/output section 40, at least any of the following generated various prompts:
the text group generation prompt TGP;
the text group evaluation prompt TEP; and
the detection prompt DP,
(ii) accept a correction instruction from the user, and
(iii) correct the at least any of the generated various prompts on the basis of the correction instruction. Then, the control section 10A may use the corrected prompt(s) in a subsequent process. This configuration makes it possible to reflect the user's intention, and therefore makes it possible to generate a more suitable prompt.

### (Application Examples)

A target to which the information processing system 100A in accordance with the present example embodiment can be applied is not particularly limited, and the information processing system 100A in accordance with the present example embodiment can be applied to various fields. As an example, the information processing system 100A in accordance with the present example embodiment may be used to ascertain the details of a work carried out by an operator in the building industry, the civil engineering industry, the manufacturing industry, and the like and to, for example, support the operator. For example, the information processing system 100A in accordance with the present example embodiment may be configured as follows: a real time image of a building site is obtained as the target image TIM and the input data IND that specifies a “human” and an “excavator” as detection targets is used so that the output information generating section 15 identifies the positional relationship between the human and the excavator in the image and then displays a warning or emits a warning sound in a case where the output information generating section 15 determines that there is a danger.

In other words, the information processing apparatus 1A may be configured such that:
the detection prompt DP that specifies a “human” and an “excavator” as detection targets is generated,
the detection prompt DP is provided to the detection model DM,
the obtaining section 14 obtains, via the communication section 30, the detection result DR that is outputted by the detection model DM into which the detection prompt DP and the target image TIM have been inputted, and
the output information generating section (warning means) 15 executes a warning process with reference to the detection result DR that has been outputted by the detection model DM.

The information processing apparatus 1A may be used to, for example, detect wearing of a safety protector at a construction site, or may be used to detect a tool used by an operator at a building site, a factory, a civil engineering site, and the like.

### THIRD EXAMPLE EMBODIMENT

The following description will discuss a third example embodiment, which is an example of an embodiment of the present invention, in detail, with reference to the drawing. The same reference signs are given to constituent elements having the same functions as those of the constituent elements described in the foregoing example embodiments, and descriptions of the constituent elements are omitted as appropriate. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing System 100B)

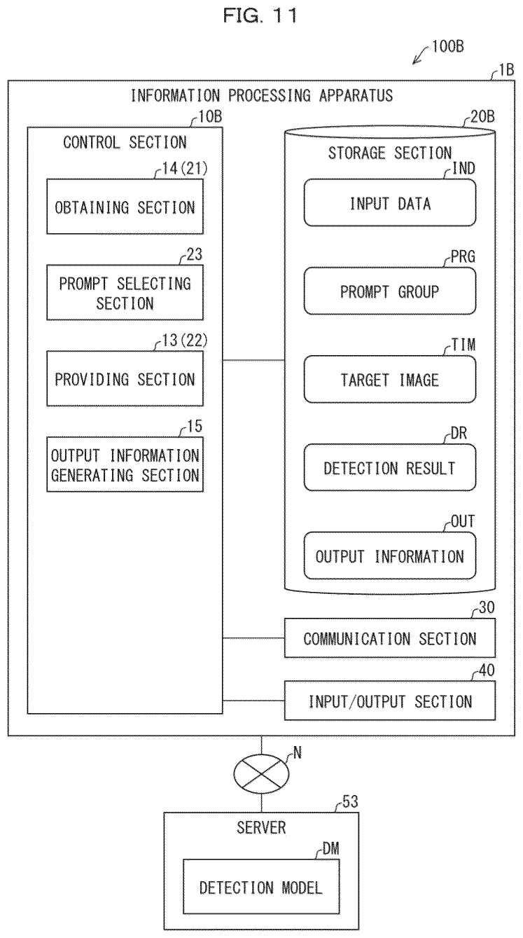

A configuration of an information processing system 100B in accordance with the present example embodiment is described with reference to FIG. 11. FIG. 11 is a block diagram illustrating the configuration of the information processing system 100B. The information processing system 100B includes, as illustrated in FIG. 11, an information processing apparatus 1B and a server 53 that is connected to the information processing apparatus 1B via a network N. The information processing system 100B does not include the servers 52 and 53 that are included in the information processing system 100A in accordance with the second example embodiment.

Further, as illustrated in FIG. 11, the information processing apparatus 1B in accordance with the present example embodiment does not include the text group obtaining section 11 and the prompt generating section 12 that are included in the information processing apparatus 1A in accordance with the second example embodiment, but includes a prompt selecting section 23. Description of that overlap with those in the second example embodiment is omitted below, and matters that differ from those in the second example embodiment are described below.

### (Prompt Selecting Section 23)

The prompt selecting section 23 selects, from a plurality of prompts included in a prompt group PRG, a detection prompt DP to be provided to a detection model DM, with reference to a phrase that is included in input data IND and that specifies a detection target.

Note, here, that, in the prompt group PRG in accordance with the present example embodiment, stored are a plurality of prompts that have been generated in a process including:
a text group obtaining process of obtaining a visually expressing text group TG that includes a plurality of texts which visually express the detection target; and
a prompt generating process of generating a prompt (detection prompt DP) with reference to the visually expressing text group TG.

As an example, in the prompt group PRG in accordance with the present example embodiment, a plurality of prompts (detection prompts DP) that have been generated by the prompt generating section 12 in accordance with the second example embodiment are stored.

Thus, the information processing apparatus 1B in accordance with the present example embodiment includes:
an obtaining means (obtaining section 14 (21)) for obtaining input data IND that specifies a detection target; and
a providing means (providing section 13 (22)) for providing, to a detection model DM, a prompt (detection prompt DP) that is obtained with reference to the input data IND, the detection model being a model into which a prompt and an image are inputted and which detects, from the image, a detection target that is specified by the prompt.

The prompt provided by the providing means is generated in a process including:
a text group obtaining process of obtaining a visually expressing text group TG that includes a plurality of texts which visually express the detection target; and
a prompt generating process of generating a prompt with reference to the visually expressing text group TG.

According to the above configuration, a suitable prompt is generated with reference to a visually expressing text group that includes a plurality of texts which visually express a detection target. Moreover, it is possible to suitably carry out object detection by a detection model with use of the suitable prompt.

### [Software Implementation Example]

Some or all of the functions of the information processing apparatuses 1, 2, 1A, and 1B (hereinafter also referred to as “each apparatus”) may be implemented by hardware such as an integrated circuit (IC chip), or may be implemented by software.

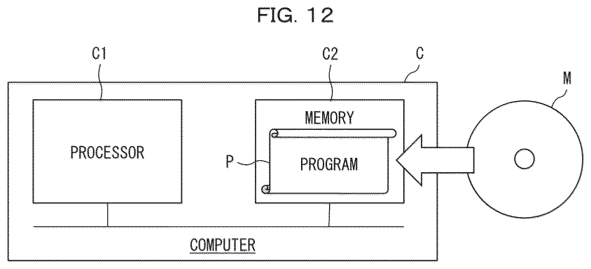

In the latter case, the each apparatus is realized by, for example, a computer that executes instructions of a program that is software realizing the functions. FIG. 12 illustrates an example of such a computer (hereinafter, referred to as a “computer C”). FIG. 12 is a block diagram illustrating a hardware configuration of the computer C which functions as the each apparatus.

The computer C includes at least one processor C1 and at least one memory C2. In the memory C2, a program P for causing the computer C to operate as the each apparatus is recorded. In the computer C, the processor C1 retrieves the program P from the memory C2 and executes the program P, so that the functions of the each apparatus are implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded in a case where the program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can be recorded in a non-transitory tangible recording medium M which is readable by the computer C. The recording medium M can be, for example, a tape, a disk, a card, a semiconductor memory, a programmable logic circuit, or the like. The computer C can obtain the program P via the recording medium M. The program P can be transmitted via a transmission medium. The transmission medium can be, for example, a communications network, a broadcast wave, or the like. The computer C can obtain the program P also via such a transmission medium.

### ADDITIONAL REMARK

The present disclosure includes techniques described in supplementary notes below. Note, however, that the present invention is not limited to the techniques described in the supplementary notes below, but may be altered in various ways by a skilled person within the scope of the claims.

### (Supplementary Note A1)

An information processing apparatus including:
a text group obtaining means for obtaining a visually expressing text group that includes a plurality of texts which visually express a detection target, with reference to input data that specifies the detection target;
a prompt generating means for generating a prompt with reference to the visually expressing text group; and
a providing means for providing, to a detection model, the prompt that has been generated in the prompt generating process, the detection model being a model into which a prompt and an image are inputted and which detects, from the image, a detection target that is specified by the prompt.

### (Supplementary Note A2)

The information processing apparatus described in Supplementary note A1, wherein
the prompt generating process carried out by the prompt generating means includes
   an evaluating process of evaluating appropriateness of at least any text included in the visually expressing text group.

### (Supplementary Note A3)

The information processing apparatus described in Supplementary note A2, wherein
the prompt generating process carried out by the prompt generating means includes
   a selecting process of selecting, from the visually expressing text group, one or more texts to be used to generate the prompt, with reference to a result of the evaluating process.

### (Supplementary Note A4)

The information processing apparatus described in Supplementary note A3, wherein
the prompt generating process carried out by the prompt generating means includes
   a searching process of searching for a text other than the one or more texts that have been selected in the selecting process, as an additional text to be used to generate the prompt.

### (Supplementary Note A5)

The information processing apparatus described in Supplementary note A4, wherein
the prompt generating process carried out by the prompt generating means includes
   a process of generating the prompt from the one or more texts that have been selected in the selecting process, in a case where the additional text is not found in the searching process.

### (Supplementary Note A6)

The information processing apparatus described in any one of Supplementary notes A2 to A5, wherein:
the text group obtaining process carried out by the text group obtaining means includes
   a process of generating a plurality of visually expressing text groups with use of a plurality of generation models that differ from each other; and
the evaluating process includes
   a process of evaluating the plurality of visually expressing text groups with use of a plurality of evaluation models that differ from each other.

### (Supplementary Note A7)

The information processing apparatus described in Supplementary note A6, wherein
the text group obtaining process includes
   a process of generating a first text group with use of a first generation model,
   a process of generating a second text group with use of a second generation model,
   a process of evaluating the second text group with use of a first evaluation model that includes the first generation model, and
   a process of evaluating the first text group with use of a second evaluation model that includes the second generation model.

### (Supplementary Note A8)

The information processing apparatus described in any one of Supplementary notes A1 to A7, further including:
an obtaining means for obtaining a detection result outputted by the detection model; and
a warning means for executing a warning process with reference to the detection result outputted by the detection model.

### (Supplementary Note A9)

An information processing apparatus including:
an obtaining means for obtaining input data that specifies a detection target; and
a providing means for providing, to a detection model, a prompt that is obtained with reference to the input data, the detection model being a model into which a prompt and an image are inputted and which detects, from the image, a detection target that is specified by the prompt,
the prompt that is provided by the providing means being generated in a process including:
   a text group obtaining process of obtaining a visually expressing text group that includes a plurality of texts which visually express the detection target; and
   a prompt generating process of generating a prompt with reference to the visually expressing text group.

### (Supplementary Note A10)

An information processing method including:
(a) obtaining a visually expressing text group that includes a plurality of texts which visually express a detection target, with reference to input data that specifies the detection target;
(b) generating a prompt with reference to the visually expressing text group; and
(c) providing, to a detection model, the prompt that has been generated, the detection model being a model into which a prompt and an image are inputted and which detects, from the image, a detection target that is specified by the prompt.

### (Supplementary Note A11)

An information processing method including:
obtaining input data that specifies a detection target; and
providing, to a detection model, a prompt obtained with reference to the input data, the detection model being a model into which a prompt and an image are inputted and which detects, from the image, a detection target that is specified by the prompt,
the prompt that is provided being generated in a process including:
   a text group obtaining process of obtaining a visually expressing text group that includes a plurality of texts which visually express the detection target; and
   a prompt generating process of generating a prompt with reference to the visually expressing text group.

### (Supplementary Note A12)

A program for causing a computer to function as an information processing apparatus,
the program causing the computer to function as:
a text group obtaining means for obtaining a visually expressing text group that includes a plurality of texts which visually express a detection target, with reference to input data that specifies the detection target;
a prompt generating means for generating a prompt with reference to the visually expressing text group; and
a providing means for providing, to a detection model, the prompt that has been generated by the prompt generating means, the detection model being a model into which a prompt and an image are inputted and which detects, from the image, a detection target that is specified by the prompt.

### (Supplementary Note A13)

A program for causing a computer to function as an information processing apparatus,
the program causing the computer to function as:
an obtaining means for obtaining input data that specifies a detection target; and
a providing means for providing, to a detection model, a prompt that is obtained with reference to the input data, the detection model being a model into which a prompt and an image are inputted and which detects, from the image, a detection target that is specified by the prompt,
the prompt that is provided by the providing means being generated in a process including:
   a text group obtaining process of obtaining a visually expressing text group that includes a plurality of texts which visually express the detection target; and
   a prompt generating process of generating a prompt with reference to the visually expressing text group.

### REFERENCE SIGNS LIST

1, 2, 1A, 1B Information processing apparatus
11 Text group obtaining section
12 Prompt generating section
121 Text group evaluating section
122 Text selecting section
13 Providing section
15 Output information generating section (warning means)
14 (21) Obtaining section
100A, 100B Information processing system

1. An information processing apparatus comprising
at least one processor,
the at least one processor executing:
a text group obtaining process of obtaining a visually expressing text group that includes a plurality of texts which visually express a detection target, with reference to input data that specifies the detection target;
a prompt generating process of generating a prompt with reference to the visually expressing text group; and
a providing process of providing, to a detection model, the prompt that has been generated in the prompt generating process, the detection model being a model into which a prompt and an image are inputted and which detects, from the image, a detection target that is specified by the prompt.

2. The information processing apparatus as set forth in claim 1, wherein
the prompt generating process includes
an evaluating process of evaluating appropriateness of at least any text included in the visually expressing text group.

3. The information processing apparatus as set forth in claim 2, wherein
the prompt generating process includes
a selecting process of selecting, from the visually expressing text group, one or more texts to be used to generate the prompt, with reference to a result of the evaluating process.

4. The information processing apparatus as set forth in claim 3, wherein
the prompt generating process includes
a searching process of searching for a text other than the one or more texts that have been selected in the selecting process, as an additional text to be used to generate the prompt.

5. The information processing apparatus as set forth in claim 4, wherein
the prompt generating process includes
a process of generating the prompt from the one or more texts that have been selected in the selecting process, in a case where the additional text is not found in the searching process.

6. The information processing apparatus as set forth in claim 2, wherein:
the text group obtaining process includes
a process of generating a plurality of visually expressing text groups with use of a plurality of generation models that differ from each other; and
the evaluating process includes
a process of evaluating the plurality of visually expressing text groups with use of a plurality of evaluation models that differ from each other.

7. The information processing apparatus as set forth in claim 6, wherein
the text group obtaining process includes
a process of generating a first text group with use of a first generation model,
a process of generating a second text group with use of a second generation model, a process of evaluating the second text group with use of a first evaluation model that includes the first generation model, and
a process of evaluating the first text group with use of a second evaluation model that includes the second generation model.

8. An information processing apparatus comprising
at least one processor,
the at least one processor executing:
an obtaining process of obtaining input data that specifies a detection target; and
a providing process of providing, to a detection model, a prompt that is obtained with reference to the input data, the detection model being a model into which a prompt and an image are inputted and which detects, from the image, a detection target that is specified by the prompt,
the prompt that is provided by the at least one processor in the providing process being generated in a process including:
a text group obtaining process of obtaining a visually expressing text group that includes a plurality of texts which visually express the detection target; and
a prompt generating process of generating a prompt with reference to the visually expressing text group.

9. An information processing method comprising:
(a) obtaining a visually expressing text group that includes a plurality of texts which visually express a detection target, with reference to input data that specifies the detection target;
(b) generating a prompt with reference to the visually expressing text group; and
(c) providing, to a detection model, the prompt that has been generated, the detection model being a model into which a prompt and an image are inputted and which detects, from the image, a detection target that is specified by the prompt,
(a) through (c) being carried out by at least one processor.

10. A non-transitory recording medium in which a program for causing a computer to function as the information processing apparatus recited in claim 1 is recorded,
the program causing the computer to execute the text group obtaining process, the prompt generating process, and the providing process.
